(19) United States
(12) Patent Application Publication
(10) Pub. No.: US 2005/0284960 A1
(43) Pub. Date: Dec. 29, 2005

(54) Multi-barreled sprayer for selective spraying a plurality of substances and / or rinse water

(76) Inventors: Jose Arevalo, Walnut Creek, CA (US); James Keys, Walnut Creek, CA (US)

Correspondence Address: THE CLOROX COMPANY, 1221 BROADWAY PO BOX 2351, OAKLAND, CA, 94623, US

(21) Appl. No.: 10/878,272

(22) Filed: Jun. 28, 2004

(51) Int. Cl. A62C 5/02

(52) U.S. Cl. 239/310

(57) ABSTRACT

A multi-barreled sprayer for applying a diluted product such as a diluted cleaning solution to a surface for cleaning thereof and rinsing the diluted product from the surface by spraying a water-only rinse onto the surface from the sprayer. The sprayer can include a flow meter therein for providing a desired product dilution ratio. To provide different spray patterns for the water rinse or diluted product, the sprayer can include a shroud having shaped exit holes. The sprayer includes separate flow paths for the water-only rinse and the diluted product. The flow path for the diluted product includes a mixing chamber in which concentrated tablet product is diluted and mixed with water supplied by a garden hose, for instance. A rotatable valve allows selective application of water or diluted product. Additional embodiments include a trigger assembly that allows selective application of water for either of the water-rinse or diluted product application.

### FIELD OF THE INVENTION

The invention relates generally to mixing and dispensing sprayers and more particularly to a sprayer for use in mixing a concentrated tablet product with water to create a desired water-product concentration, and spraying the thus diluted product onto a surface to be treated. The concentrated tablet product may be a hydrolyzer such as a surfactant, including soap for floor, bathroom and/or exterior siding cleaning, or it may be a wax or water softener treatment to be used for cleaning a vehicle/improving a vehicle's appearance. The sprayer may also be used to apply a water-only rinse to remove the diluted product from the surface.

### BACKGROUND OF THE INVENTION

Sprayers for mixing and dispensing liquids into a carrier fluid such as water are disclosed in U.S. Pat. Nos. 3,201,049; 3,381,899; 5,039,016; 5,100,059; 5,213,265; 5,383,603; 5,595,345; and 5,850,973. Such sprayer arrangements typically include an inlet for a hose such as a garden hose and an inlet for a siphon tube, wherein the inlet for the siphon tube is for moving a liquid soap from a container attached to a sprayer through use of a Venturi vacuum.

The sprayer arrangements vary in complexity and typically spray a water/liquid product mixture or water-only through a common outlet of the sprayer. Further, in some known arrangements, the liquid product to be mixed with water is mixed in a chamber exposed to the atmosphere, resulting in fluctuations of the water-product ratio. Additional problems of such prior art sprayers are that they may not be capable of delivering a water/liquid product mixture or a water-only rinse over a suitable distance. Further, such sprayers require the attachment of a heavy liquid soap container in order to provide enough soap for a particular usage (e.g., washing a car), thus leading to user fatigue. There is a need in the art for a sprayer apparatus which can selectively apply a diluted product mixture and/or a water-only rinse that does not necessarily add to user fatigue.

### SUMMARY OF THE INVENTION

The invention provides a portable multi-barreled sprayer for applying a diluted product to a surface to be treated. The sprayer may include a housing having a water supply inlet and a concentrated tablet insertion point/mixing chamber, first and second outlets, and a valve member. The water supply inlet is attached to a water supply such as a hose which supplies water to the sprayer. The concentrated tablet insertion point may be attached to a mixing chamber which supplies a concentrated tablet product which has been diluted in water to provide a diluted product. The mixing chamber is in fluid communication with the water supply inlet such that water is mixed with the concentrated tablet product to produce a diluted product by feeding water through the water supply inlet to the mixing chamber. The first outlet sprays the diluted product from the sprayer onto the surface to be treated. The second outlet sprays rinsing water from the sprayer to allow removal of diluted product from the surface to be treated. The valve member selectively feeds the diluted product to the first outlet or feeds a water rinse to the second outlet. The valve member may also completely isolate the water supply from both the first and second outlets.

The sprayer can include a variety of optional features. For instance the sprayer can include dual dip tubes extending into a container wherein the concentrated tablet product dilutes in water. The diluted product can be removed from the container by feeding water through the mixing chamber via the first dip tube and siphoning the diluted table product from the container using a Venturi vacuum via the second dip tube, for instance.

In other embodiments, water flows from the water supply inlet and is diverted directly into the mixing chamber thereby causing the concentrated tablet product to dilute, whereby the diluted product is then removed from the mixing chamber to the second outlet without assistance from a Venturi vacuum.

In another embodiment, the sprayer has a tube that is parallel to the flow of water as an inlet to the mixing chamber. This provides water to the concentrated tablet product, and the diluted product is then sprayed from the second outlet through use of both a Venturi vacuum and pressurized water.

The sprayer includes a valve member which can be a rotatable valve having a cylindrical body with first and second passages therethrough. The first passage is in fluid communication with the water supply inlet and the first outlet when the rotatable valve is in a first position, and when the rotatable valve is rotated from the first position to a second position the second passage is in fluid communication with the water supply inlet and the second outlet (at which position the first passage is not in fluid communication with the water supply inlet). The valve member can include a seal member, which sealingly engages the first and second passages when the valve member is in an off position.

The first passage may be for delivery of the diluted product, and the second passage may provide a water-only rinse. The first passage includes an upstream portion and a downstream portion, wherein the mixing chamber is in fluid communication with the downstream portion. The downstream portion has a larger cross-section than the upstream portion so that, in certain embodiments, the diluted product is siphoned into the downstream portion via a Venturi effect from water flowing from the upstream portion to the downstream portion. The water may be supplied to the sprayer by a water hose and diluted product may be supplied to the sprayer from a container wherein the concentrated tablet product has been diluted.

To attach the container, the housing can include a tubular projection such as a bayonet stub and a rotatable fitting mounted on a tubular projection such that the rotatable fitting is engageable with the container. In other embodiments, the container has female threads which mate with male threads on the sprayer. To attach a hose, a typical garden hose may be employed, such as one with male threads which mate with female threads on the sprayer.

The sprayer may also include a flow meter for delivering a precise amount of water for mixing with the concentrated tablet product, thereby providing a substantially precise tablet/water mixture. The sprayer may also include a window in a side of the sprayer thereby enabling a user to view the concentrated tablet product within the sprayer.

### BRIEF DESCRIPTION OF THE DRAWINGS

FIG. 1 illustrates an embodiment of the invention wherein the sprayer is in a partially exploded and cross-sectional view including a container attachable to the sprayer wherein the container contains the concentrated tablet product;

FIG. 2 illustrates an embodiment of the invention in a partially exploded and cross-sectional view including a wall that diverts water from the sprayer directly into the container wherein the container includes the concentrated tablet product;

FIG. 3 shows an embodiment of the invention in a partially exploded and cross-sectional view wherein the container includes an inlet tube for directing water into the container so as to enable the dilution of the concentrated tablet product;

FIG. 4a shows an embodiment of the invention in a partially exploded and cross-sectional view illustrating the function of the water control knob selector switch wherein water is allowed to flow from the water supply inlet to the first passage and water is blocked from flowing to the second passage;

FIG. 4b shows an embodiment of the invention in a partially exploded and cross-sectional view illustrating the function of the water control knob selector switch wherein water is allowed to flow from the water supply inlet to the second passage and water is blocked from flowing to the first passage;

FIG. 5 is an illustration of an embodiment of the invention in a partially exploded and cross-sectional view showing a handle and trigger embodiment;

FIG. 6 shows an illustration of an embodiment of the invention in a partially exploded and cross-sectional view not including the container as shown in FIG. 1;

FIG. 7a is a side-view illustration of an embodiment of the invention including a hinged biased closure allowing insertion of a concentrated tablet product;

FIG. 7b is an illustration of an embodiment of the invention showing a bottom view of a hinged biased closure for insertion of a concentrated tablet product;

FIG. 8 is an illustration of embodiments of the invention showing a built-in flow meter for adjusting a preferred concentration of the concentrated tablet product and a tablet viewing window; and

FIG. 9 is an illustration of an embodiment of the invention, including a multi-dose concentrated tablet insertion apparatus.

### DETAILED DESCRIPTION OF EMBODIMENTS

According to the invention, an improved multi-barreled sprayer is provided having improved consistency and water product mixing ratios, range of delivery, and/or different spray patterns for a diluted concentrated tablet product mixture or a water-only rinse. The multi-barreled sprayer can incorporate a closed Venturi system, an orifice plate delivery mechanism, a dual chamber exit for delivery of water only from one exit hole and diluted product from another exit hole. The sprayer may include a three position valve for supplying a diluted product mixture in a first position, rinse water in a second position, and for preventing outflow of both diluted product and water in a third position.

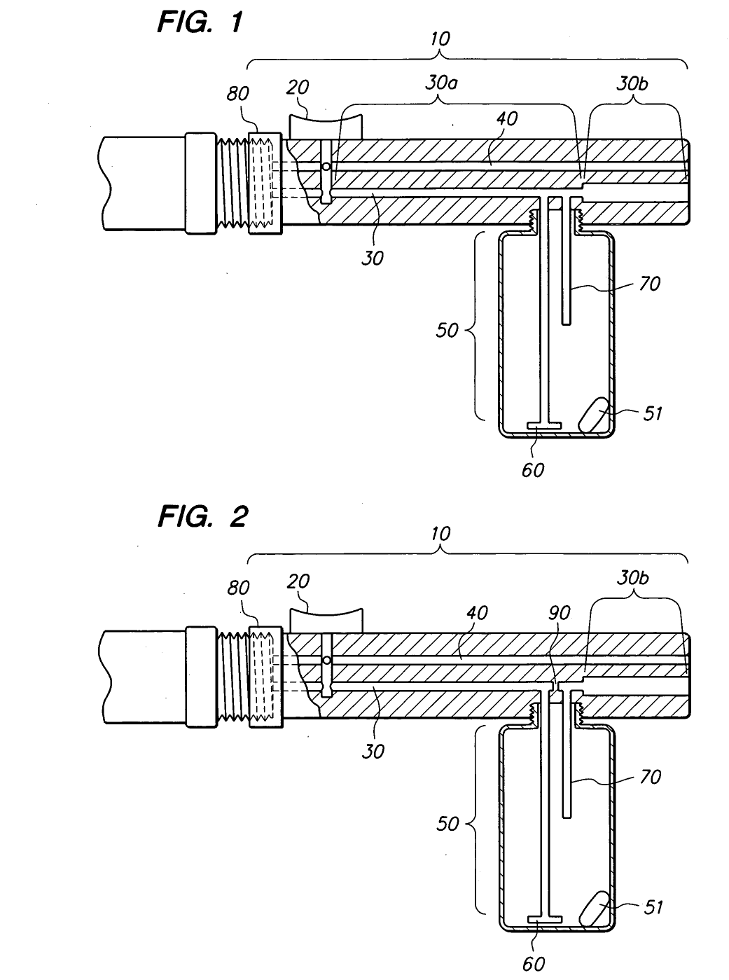

FIG. 1 is an illustration of one embodiment according to the invention showing sprayer body 10 which includes water diverter knob 20, first chamber 30, second chamber 40, container 50, first dip tube 60, second dip tube 70, water inlet 80, concentrated tablet product 51, and an upstream portion of the first chamber 30a and a downstream portion of the first chamber 30b. The sprayer body 10 may be made of plastic, rubber, polyethylene, polypropylene, and/or metal or other substances known in the art. The concentrated tablet product may be a hydrolyzer such as a surfactant, soap, water softener, wax and/or other cleaning or appearance-improving material.

Water diverter valve 20 functions to operate in at least one of three positions. A first position allows water to flow into the first chamber 30 from water supply inlet 80 to thereby mix with the concentrated tablet product. A second position of water diverter valve 20 opens the water supply inlet 80 to the second chamber 40, as a water-only rinse out of sprayer body 10. A third position of water diverter valve 20 shuts off water to both the first chamber 30 and the second chamber 40. Water supply inlet 80 may be connected to an ordinary garden hose, by way of example. In other embodiments, water supply 80 may be a water container such as a bucket or water pump. In addition, the functions of the first and second chambers/passages 30 and 40 may be reversed. Further, the first and second chambers/passages may be either of lower and upper chambers, or may be side-to-side, or may be slanted obliquely (cross-wise) in relation to each other. That is, the first and second chambers 30 and 40 need only be physically separate within the cross-section of the sprayer body 10.

As noted above, second passage 40, when diverter valve 20 is in a proper position, allows for a water-only rinse to exit the sprayer body 10. First passage 30, when diverter valve 20 is in the proper position, allows water to flow to container 50. Container 50 may include dip tubes 60 and 70. In one embodiment, dip tube 60 is a first dip tube which is lower in comparison to dip tube 70, thereby allowing clean water to reach the bottom of container 50. Second dip tube 70 is an outlet dip tube used to supply diluted product to the outlet of the lower passage 30.

In certain embodiments, lower passage 30 may include a narrow upstream portion 30a and a larger downstream portion 30b. Because the upstream portion 30a has a narrower cross-section than the downstream portion 30b, a Venturi effect is created above dip tube 70 allowing for siphoning of diluted concentrated tablet product to occur. When diverter valve 20 is in the proper position for water to flow through the first chamber 30, water dilutes the concentrated tablet product 51 in the container 50. Diluted product, such as a soap solution, is then sprayed out of the first passage 30 to be used for washing a car or the side of a house, for instance.

When a user has completed the washing portion of their task at hand, the user simply changes the water diverter valve 20 to a position that allows for a rinse of the surface that was treated by the soap solution provided by the first passage 30. In between washing and rinsing, the user has the option of completely turning off sprayer body 10 by simply moving diverter valve 20 to a proper position.

FIG. 2 illustrates an additional embodiment of the invention including a wall 90 which diverts water from first passage 30 into container 50. Such features that are similar in nature as compared to FIG. 1 will not be additionally described as such would be redundant. FIG. 2 illustrates first passage 30 being obstructed by wall 90 which diverts water flow from inlet 80 through water knob diverter valve 20 to first dip tube 60. Water is then forced through first dip tube 60 into container 50 where the water dilutes the concentrated tablet product to provide a preferred concentration of diluted product which is then forced up second dip tube 70 and out of the downstream portion 30b of sprayer body 10.

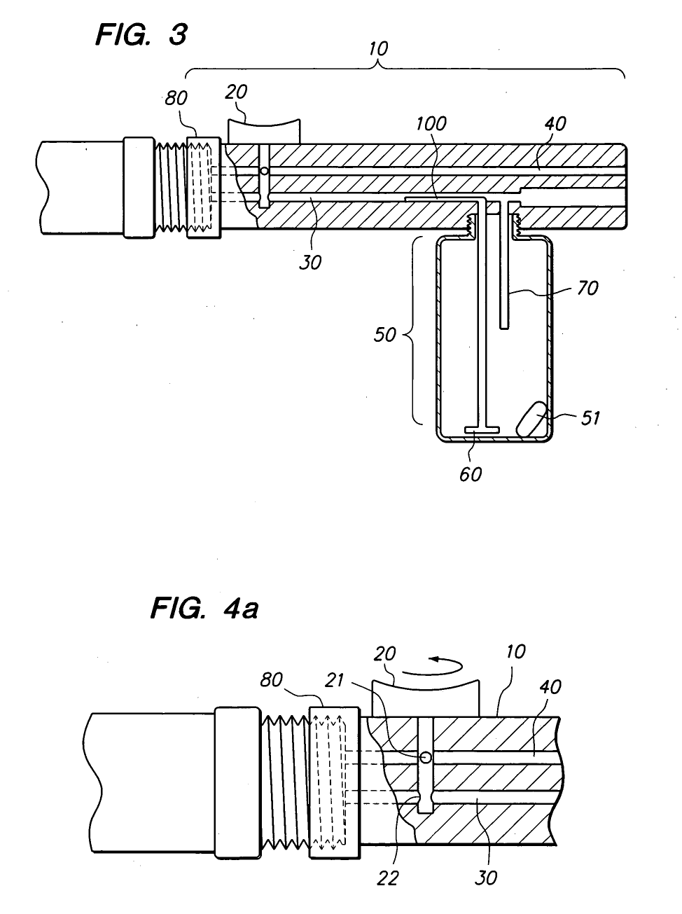

FIG. 3 illustrates an additional embodiment of the invention showing inlet tube 100 which runs parallel to the upstream portion of first passage 30 but does not completely obstruct first passage 30. In this embodiment, only a portion of the water flow is diverted into container 50. As a result, there is some Venturi effect which occurs over the second dip tube 70 as the downstream portion 30b of the first passage 30 is larger in cross-section than the upstream portion 30a of first passage 30. That is, first passage 30 encounters a Venturi effect above second dip tube 70 by virtue of the flow of water above dip tube 70 in first passage 30 when running from upstream 30a to downstream portion 30b by virtue of downstream portion 30b having a larger cross-section than upstream portion 30a.

While downstream portion 30b is larger in cross-section than upstream portion 30a in certain embodiments, in other embodiments the two portions 30a and 30b may have comparable cross-sections. In addition, the cross-section of first and second passages 30, 40 need not be the same size, and either may be larger than the other.

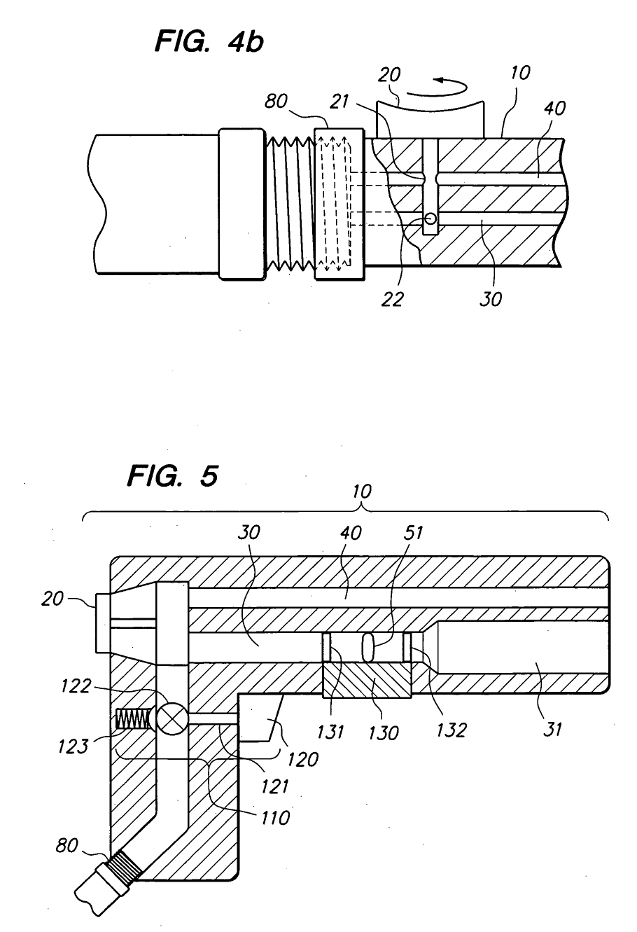

FIG. 4a illustrates an embodiment of the invention showing the water diverter valve 20 and its specific operation wherein through-hole 22 is in fluid communication with both water inlet 80 and first passage 30. Water diverter valve 20 either obstructs or allows passage through and to both second passage 40 and first passage 30 by virtue of the user rotating selector knob 20. Alignment holes 21 and 22 for passages 40 and 30, respectively, are either aligned or not aligned for the flow of water to occur from water supply inlet 80 through water diverter knob 20 to either of passages 40 and 30. Additionally, water diverter valve 20 may be moved to a position whereby holes 21 and 22 are both offset such that no water is allowed to pass diverter valve 20 into passages 40 or 30. That is, the diverter valve 20 may cut off first and second passages 30 or 40 through rotation of holes 22 and 21, such that the holes are out-of-alignment with both first and second passages 30 and 40, respectively.

FIG. 4b illustrates an embodiment of the invention showing the water diverter valve 20 and its specific operation wherein through-hole 21 is in fluid communication with both water inlet 80 and second passage 40. The rotational arrow shown in FIG. 4b indicates that valve 20 has been rotated by a user, aligning the through-hole 21 as described above.

FIG. 5 illustrates an embodiment of the invention showing a handle portion and a trigger portion. Sprayer body 10 is similar in some respects to the sprayer shown in FIG. 1 and the description of similar features is not repeated to avoid redundancy. As illustrated in FIG. 5, the sprayer includes a handle portion including trigger portion 110. Trigger portion 110 includes trigger 120, rod 121, diverter ball 122, and spring 123. The spring 123 biases diverter ball 122 so that, in a natural state, diverter ball 122 stops all flow of water from water supply inlet 80 downstream to diverter valve/knob 20. When a user depresses trigger 120, rod 121 moves in a rearward direction towards diverter ball 122, engages diverter ball 122, and compresses spring 123 thereby allowing water from water supply inlet 80 to flow to diverter valve/knob 20. Diverter valve/knob selector switch 20 operates in similar fashion as that described in relation to FIGS. 4a and 4b for providing passage of water to the first passage 30 and the second passage 40. The first passage 30 provides a flow of diluted concentrated tablet product out of sprayer body 10. The second passage 40 provides a rinse water flow out of sprayer body 10. Diverter valve/knob 20 may also be positioned to an off position in additional embodiments.

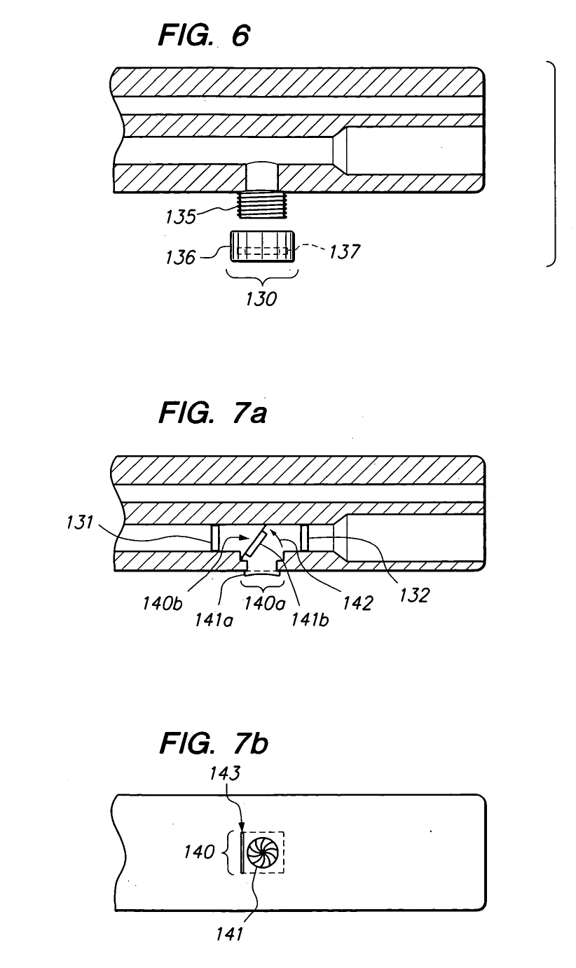

Additionally illustrated in FIG. 5, sprayer body 10 includes a tablet insertion point 130. Tablet insertion point 130 is described in further detail in relation to FIGS. 6, 7a, and 7b. When water diverter valve 20 is in the proper position, water flows into first passage 30 and flows through first screen 131 and therein encounters the concentrated tablet product 51 which is contained between first screen 131 and second screen 132, above tablet insertion point 130. A dilution of concentration tablet product in water is thereby provided to the downstream portion 30b, which in this embodiment acts as a mixing chamber. The diluted product is then sprayed from sprayer body 10 onto a surface to be treated.

As described above in relation to FIG. 1, once the surface to be treated has been treated with the diluted product resulting from a dilution of the concentrated tablet product 51 in water, the selector knob 20 may be moved to allow clean water to flow through second passage 40 to provide a rinse for the surface to be treated.

FIG. 6 illustrates an embodiment of the tablet insertion point 130 including male threaded portion 135 and cap 136. As illustrated, cap 136 may be removed from tablet insertion point 130 allowing for a tablet to be inserted. Once concentrated tablet product 51 is inserted into tablet insertion point 130, cap 136 may be threaded onto threads 135 and is thereby sealed with gasket 137, providing a watertight closure.

FIG. 7a is an illustration of a partially exploded and cross-sectional view of another embodiment of the invention including biased-hinged flapper valve 140 which works in conjunction with first and second screens, 131 and 132, wherebetween a concentrated tablet product is inserted through the biased-hinged flapper valve 140. Biased-hinged flapper valve 140 includes a hinged portion 143 (hinged portion 143 is depicted in FIG. 7b) that allows for the tablet insertion portion to pivot such that a concentrated tablet product may be inserted into the first passage 30. That is, the biased-hinged flapper valve 140 is capable of moving to at least one of two positions when no water pressure is applied within first passage 30. With no water pressure applied to first passage 30, the biased-hinged flapper valve 140 is capable of pivoting on its hinge such that a concentrated tablet product may be inserted. Once water pressure is introduced to first passage 30, the biased-hinged flapper valve 140 is pressed completely in a sealed position against sprayer body 10 such that water flows from upstream portion 30a to downstream portion 30b and does not exit from the tablet insertion portion. The biased-hinged flapper valve 140, as noted, includes first position 140a in which the valve 140 is sealingly set against sprayer body 10. The valve 140 pivots to a second position 140b, thereby allowing insertion of a concentrated tablet product into first passage 30.

FIG. 7b is an illustration of valve 140 from a bottom view that includes hinged portion 143 and flexible membrane portion 141. Flexible membrane portion 141 may be any form of plastic or rubber that provides a divot-like space or a particular position for concentrated tablet product 51 to rest once it has been inserted into passage 30. The valve 140 operates as described in relation to FIG. 7a.

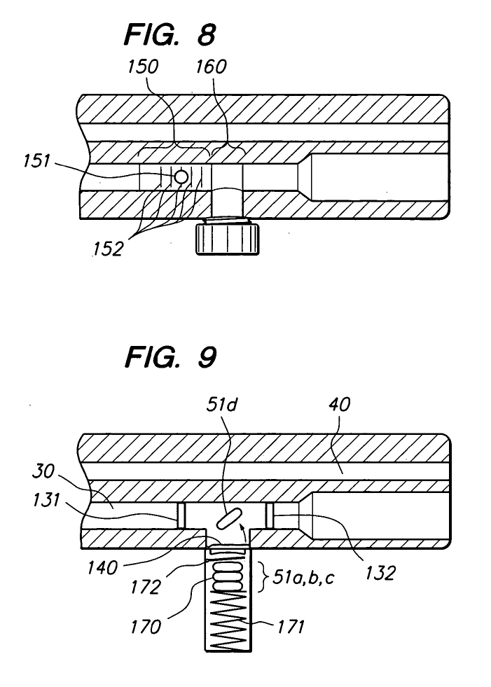

FIG. 8 is an illustration of an embodiment of the invention including at least one of flow meter 150 and tablet viewing window 160. Flow meter 150 is a visible flow meter by which a user may adjust a flow of water through first passage 30 to provide a specific and preferred concentration of the, concentrated tablet product 51 in water. As varying households have distinct ranges of supplied water pressure, water inlet 80 may have a range of water pressure anywhere from 40 to 60 psi, for example. Accordingly, built-in visible flow meter 150 provides the user with the ability to apply a preferred concentration of the concentrated tablet product 51 as it dilutes in water according to the precise flow of water which depends upon the water pressure supplied to water inlet 80, for instance, as shown in FIG. 1.

Visible flow meter 150 includes flow meter ball 151 and sight gradation increment viewing symbols 152. To use visible flow meter 150, a user would simply hold the sprayer body 10 vertically while adjusting the water diverter valve 20 to derive the preferred flow to provide a substantially precise concentration of concentrated tablet product 51 as it dissolves at a particular rate in a particular flow of water. Tablet viewing window 160, in another embodiment of the invention, may be translucent to enable a viewer to view how much of concentrated tablet product 51 remains within the insertion point for the concentrated tablet product.

FIG. 9 is an illustration of another embodiment of the invention including multi-dose tablet dispenser-inserter 170. Multi-dose tablet dispenser-inserter 170 includes biasing spring 171 and mechanical action arm 172. When a user operates mechanical action arm 172, a concentrated tablet product 51a, b, c, or d is inserted into passage 40 via flapper valve 140 (valve 140 is shown in FIG. 9 in a closed position). Upon completion of the mechanical operation of mechanical arm 172, flapper valve 140 is allowed to close, thereby allowing the water pressure to completely seal flapper valve 140 and preventing water from leaking into multi-dose tablet dispenser-inserter 170. Multi-dose tablet dispenser-inserter 170 may attach to sprayer body 10 by a number of means including a tapered sleeve that fits circumferentially around sprayer body 10 such that the tapering portion of multi-dose tablet dispenser-inserter 170 comes to rest against sprayer body 10 when the body of multi-dose tablet dispenser-inserter 170 rests beneath flapper valve 140. Other forms of attachability include connectivity known in the art including tabs, screws, and/or clips, as would be well-known to one of ordinary skill in the art. Spring 171 provides a biasing force against concentrated tablet products 51a, b, and c, respectively, such that as individual doses of concentrated tablet products 51a, b, and c are inserted through flapper valve 140, concentrated tablet products 51a, b, and c move upwards in relation to the multi-dose tablet dispenser inserter 170 body.

As described above, alternative embodiments of the concentrated table insertion point 130 include the cap 136 and the valve 140. Additional embodiments include a hinged drawer with appropriate sealing/gasket material, a slot with a deformable membrane and/or a snap/compression closure.

Additional embodiments of the invention include an orifice plate delivering mechanism on the output side of the sprayer body 10 thereby allowing for various sizes, mists, and pulses of water as they leave passages 30 and 40 of sprayer body 10.

The foregoing describes the principles, embodiments, and modes of operation of the present invention. However, the invention should not be construed as being limited to the particular embodiments discussed. Thus, the above-described embodiments should be regarded as illustrative rather than restrictive. It should be appreciated that variations may be made in those embodiments by workers skilled in the art without departing from the scope of the present invention as defined by the following claims. Additional embodiments may include various features taken from any of the various embodiments described herein in various combinations. Further additional embodiments may omit certain features as the ordinarily skilled artisan would understand how to combine various aspects of the present invention without, perhaps, including all aspects of the above-described embodiments.

1. A portable sprayer for applying a diluted product to a surface to be treated, the sprayer comprising:
a housing having a water supply inlet, a concentrated tablet insertion point, first and second outlets, a mixing chamber, and a valve member;
the water supply inlet supplying water to the sprayer;
the concentrated tablet insertion point supplying a concentrated tablet product to the sprayer;
the mixing chamber being in fluid communication with the water supply inlet and the first outlet such that water is mixed with the concentrated tablet product to form a diluted product by feeding water through said valve member from said water supply inlet;
the second outlet spraying rinsing water from the sprayer to allow removal of diluted product from a surface to be treated;
the first outlet spraying the diluted product from the sprayer onto a surface to be treated; and
the valve member being operable to selectively feed the diluted product to the first outlet or feed rinsing water to the second outlet.

2. The sprayer of claim 1, further comprising a container for containing the concentrated tablet product, the container being attachable to the sprayer and the diluted product being removed from the container by flowing water through the first outlet and siphoning the diluted product from the container.

3. The sprayer of claim 1, further comprising a cover member attached to the housing, said cover member including first and second outlets, the first outlet of the cover member being in fluid communication with the first outlet of the housing and the second outlet of the cover member being in fluid communication with the second outlet of the housing.

4. The sprayer of claim 3, wherein the cover member includes a spray pattern member attached thereto, the spray pattern member being fixedly attached to the cover member, the first and second outlets of the cover member being located on the spray pattern member.

5. The sprayer of claim 1, wherein the valve member comprises a rotatable valve, the rotatable valve including a cylindrical body having first and second passages therethrough, the first passage being in fluid communication with the water supply inlet and the first outlet when the rotatable valve is in a first position, and the second passage being in fluid communication with the water supply inlet and the second outlet when the rotatable valve is in a second position at which position the first passage is not in fluid communication with the water supply inlet.

6. The sprayer of claim 1, wherein the housing includes a bore and the valve member includes a cylindrical body fitted in the bore of the housing, the housing further including a first passage in fluid communication with the first outlet when the valve member is in a first position, and a second passage in fluid communication with the second outlet when the valve member is in a second position, and further wherein the valve member includes a seal member which seals both the first and second passages when the valve member is in a third position.

7. The sprayer of claim 1, wherein the housing includes a bore receiving the valve member, an first passage extending between the bore and the first outlet, a second passage extending between the bore and the second outlet, and a cavity in fluid communication with the bore and the water supply inlet, the valve member being movable from a first position at which the cavity is in fluid communication with only the first passage to a second position at which the cavity is only in fluid communication with the second passage.

8. The sprayer of claim 1, further comprising a passage in fluid communication with the water supply inlet, the concentrated tablet insertion point, and the second outlet, the passage including an upstream portion and a downstream portion, the concentrated tablet insertion point being in fluid communication with the downstream portion, and the downstream portion having a larger cross section than the upstream portion such that the diluted product is siphoned by a Venturi effect into the downstream portion for ejection from said sprayer.

9. The sprayer of claim 1, wherein the water supply inlet comprises an internally threaded portion of the housing, the internally threaded portion being attachable to a garden hose by screwing the internally threaded portion onto an externally threaded portion of the garden hose.

10. The sprayer of claim 1, further comprising a flow meter in fluid communication with the water supply inlet and concentrated tablet insertion point, the flow meter enabling said diluted product to be ejected from said sprayer in a substantially constant water-product ratio.

11. The sprayer of claim 2, further comprising first and second dip tubes contained within said container, said first dip tube being in fluid communication with said water supply inlet and an internal portion of said container, said second dip tube being in fluid communication with said internal portion of said container and said first outlet.

12. The sprayer of claim 1, further comprising a handle with a trigger wherein said trigger permits or interrupts said water flow from said water supply inlet.

13. The sprayer of claim 1, wherein said concentrated tablet insertion point comprises a flapper valve.

14. The sprayer of claim 1, wherein said concentrated tablet insertion point comprises a threaded portion closable with a cap portion.

15. The sprayer of claim 1, wherein said concentrated tablet insertion point comprises a container with a bayonet stub attachment.

16. The sprayer of claim 1, wherein said mixing chamber further comprises a screened portion for concentrated tablet product containment.

17. The sprayer of claim 1, further comprising a multi-dose attachment for insertion of individual concentrated tablet products into said concentrated tablet insertion point.

18. The sprayer of claim 1, wherein said housing further comprises a flow meter.

19. The sprayer of claim 1, wherein said housing further comprises a concentrated tablet product viewing window.

20. The sprayer of claim 1, wherein said concentrated tablet product is selected from the group consisting of: water softener, surfactant, wax, hydrolyzer, and soap.

21. The sprayer of claim 1, wherein said diluted product is selected from the group consisting of: water softener, surfactant, wax, hydrolyzer, and soap.
